(19) United States
(12) Patent Application Publication
(10) Pub. No.: US 2010/0332644 A1
(43) Pub. Date: Dec. 30, 2010

(54) OPTIMIZATION OF APPLICATION DELIVERY IN A VIRTUAL UNIVERSE

(75) Inventors: Ann Corrao, Research Triangle Park, NC (US); Rick A. Hamilton, II, Richmond, VA (US); Brian M. O'Connell, (US); Brian J. Snitzer, West Chester, PA (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/491,450

(22) Filed: Jun. 25, 2009

(51) Int. Cl. G06F 15/173

(52) U.S. Cl. 709/224; 709/226; 715/757

(57) ABSTRACT

An approach is provided for optimizing delivery of virtual universe applications to users of said virtual universe applications. In one embodiment, there is an optimizing tool, including a ranking component configured to rank types of communication methods based on frequency of utilization of said communication methods by a user. The optimization tool further includes a determining component configured to determine a most desirable optimization technique for each available communication method used the most by said user.

### FIELD OF THE INVENTION

This invention relates generally to virtual universes and more specifically to optimizing methods of delivery of virtual universe applications to users by prioritizing types of communication methods based on users' communication preferences previously used.

### BACKGROUND OF THE INVENTION

Virtual universes or virtual worlds are computer-based simulated environments intended for its users or residents to inhabit and interact via avatars, which are personas or representations of the users of the virtual universes. These types of virtual universes are now most common in massively multiplayer online games such as Second Life®, which is a trademark of Linden Research Inc. in the United States. Avatars in these types of virtual universes, which can number well over a million, have a wide range of business and social experiences.

Such virtual worlds involve complex interactions, whereas users are employing a variety of communication mechanisms to interact with avatars. The interactions further involve communications between avatars within virtual universe and between avatars and other objects within such universe. Presently, these interactions are all executed using native protocols associated with each object type, i.e., HTTP for textures, RTSP for audio or video, SIMPLE or SIP for Instant Messaging, etc.

While some forms of caching are used to accelerate access to objects, methods are not employed to improve communications over the protocols themselves. In other words, no determination is performed to find which protocol is used most heavily by a given user. Such determination would benefit the communication process greatly, as it will allow for optimization of a protocol utilized the most, therefore resulting in streamlining the communication process in general.

### SUMMARY OF THE INVENTION

The current invention describes methods for prioritizing communication types in a Virtual Universe. Different communication protocols are used for different entities, such as objects, messages, textures, audio and scripts. The currently proposed method allows for associating each communication method with its sensitivity latency. A user's usage of each communication method is tracked to determine the communication method that should receive priority. Communication optimization methods are then applied to ensure that the prioritized communication types receive the most efficient optimization technique.

The methods presently described allow for tracking of all types of communication methods used, and prioritizing of such methods by usage thereafter. Such tracking, in turn, permits detection of the communication types that should receive prioritized attention for protocol optimization.

The prioritized communication methods thereafter receive application of the most efficient optimization techniques within a protocolizer, which is a component described in greater detail below. This optimization improves users' experience by ensuring that the most important communication methods receive priority and that the most efficient optimization techniques are applied to such methods.

The described method further enables the most efficient usage of user's prioritized communication types in a Virtual Universe. Since a Virtual Universe is a multidimensional environment, such environment permits many different types of communications concomitantly. Use of such an environment, therefore, differs greatly from a standard web browsing experience.

To ensure the best user experience, a system optimizes only the most used communication types and ensures that the most appropriate optimization techniques are applied for delivery of the most used communication method. Such approach, therefore presents a great advantage, since most optimizations have a resulting utilization cost, such as CPU consumption, network consumption, etc., making it greatly disadvantageous to optimize all communication types within a virtual universe.

In one embodiment, there is a method for optimizing delivery of virtual universe applications to users of such virtual universe applications, the method comprising: ranking types of communication methods based on frequency of utilization of such communication methods by a user; determining a most desirable optimization technique for each available communication method for the application, and utilizing the most desirable optimization technique for delivering a most frequently used communication method.

In a second embodiment, there is a computer system for optimizing delivery of virtual universe applications to users of such virtual universe applications, the system comprising: at least one processing unit; memory operably associated with the at least one processing unit; and an optimization tool storable in memory and executable by the at least one processing unit, the optimization tool comprising: a ranking component configured to rank types of communication methods based on frequency of utilization of such communication methods by a user; a determining component configured to determine a most desirable optimization technique for each available communication method for the application, and a utilizing component configured to utilize the most desirable optimization technique for delivering a most frequently used communication method.

In a third embodiment, there is a computer-readable medium storing computer instructions, which when executed, enable a computer system to provide optimizing delivery of virtual universe applications to users of such virtual universe applications, the computer instructions comprising: ranking types of communication methods based on frequency of utilization of such communication methods by a user; determining a most desirable optimization technique for each available communication method for the application, and utilizing the most desirable optimization technique for delivering a most frequently used communication method.

In a fourth embodiment, there is a method for deploying an optimization tool for use in a computer system that provides optimizing delivery of virtual universe applications to users of such virtual universe applications, the method comprising: providing a computer infrastructure operable to: rank types of communication methods based on frequency of utilization of such communication methods by a user; determine a most desirable optimization technique for each available communication method for the application, and utilize the most desirable optimization technique for delivering a most frequently used communication method.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some of the functionalities provided by the server array shown in FIG. 1;

FIG. 5 shows an optimization component according to one embodiment of this invention that operates in the environment shown in FIG. 1;

FIG. 6 shows a schematic of an exemplary computing environment in which elements of the networking environment shown in FIG. 1 may operate; and

FIG. 7 illustrates a block diagram of a method for optimizing delivery of virtual universe applications to users of such virtual universe application according to one embodiment of the invention.

FIG. 8 shows a flow chart of a method for optimizing delivery of virtual universe applications to users of said virtual universe applications according to one embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to optimizing delivery of virtual universe applications to users of such virtual universe applications in a virtual universe, such that wait times for the rendering of virtual content are reduced. In these embodiments, an optimization tool provides the capability to optimize delivery of virtual universe application based on frequency of communication methods used for such delivery of the applications. Specifically, the ranking component ranks types of communication methods based on frequency of utilization of the communication method, a determining component determines a most desirable optimization technique and utilization component utilizes the most desirable optimization technique for delivering the most frequently used communication method.

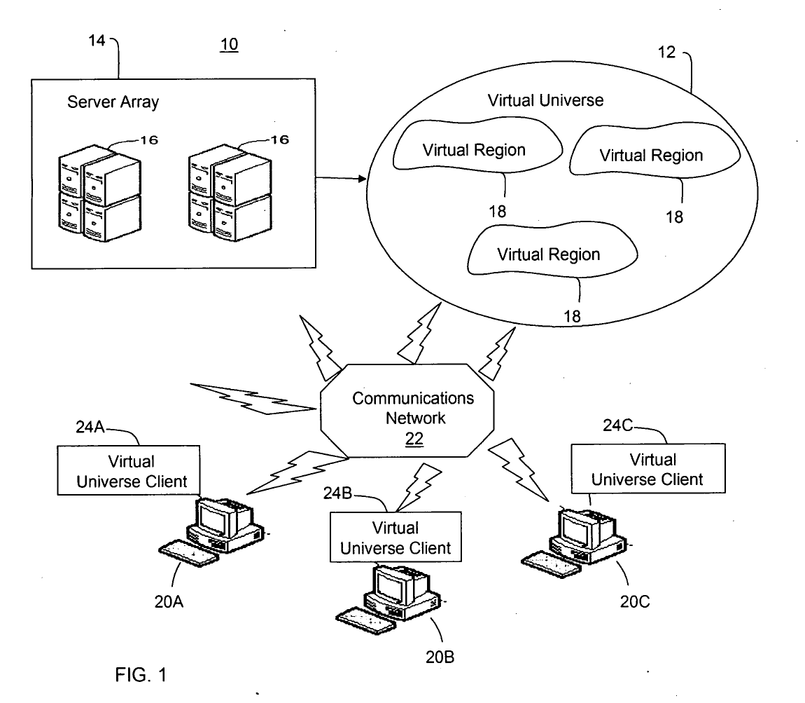

FIG. 1 shows a high-level schematic diagram showing a networking environment 10 for providing a virtual universe 12 according to one embodiment of this invention in which a service for optimizing delivery of virtual universe applications can be utilized. As shown in FIG. 1, networking environment 10 comprises a server array or grid 14 comprising a plurality of servers 16, each responsible for managing a portion of virtual real estate within virtual universe 12. A virtual universe provided by a multiplayer online game, for example, can employ thousands of servers to manage all of the virtual real estate. The virtual content of the virtual real estate that is managed by each of servers 16 within server array 14 shows up in virtual universe 12 as a virtual region 18 made up of objects, textures and scripts. Like the real-world, each virtual region 18 within virtual universe 12 comprises a landscape having virtual content, such as buildings, stores, clubs, sporting arenas, parks, beaches, cities and towns all created by residents of the universe that are represented by avatars. These examples of virtual content are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20C (hereinafter referred generally as 20) interact with virtual universe 12 through a communication network 22 via virtual universe clients 24A-24C (hereinafter referred generally as 24) that reside in computers 20, respectively. Below are further details of virtual universe 12, server array 14, and virtual universe client 24.

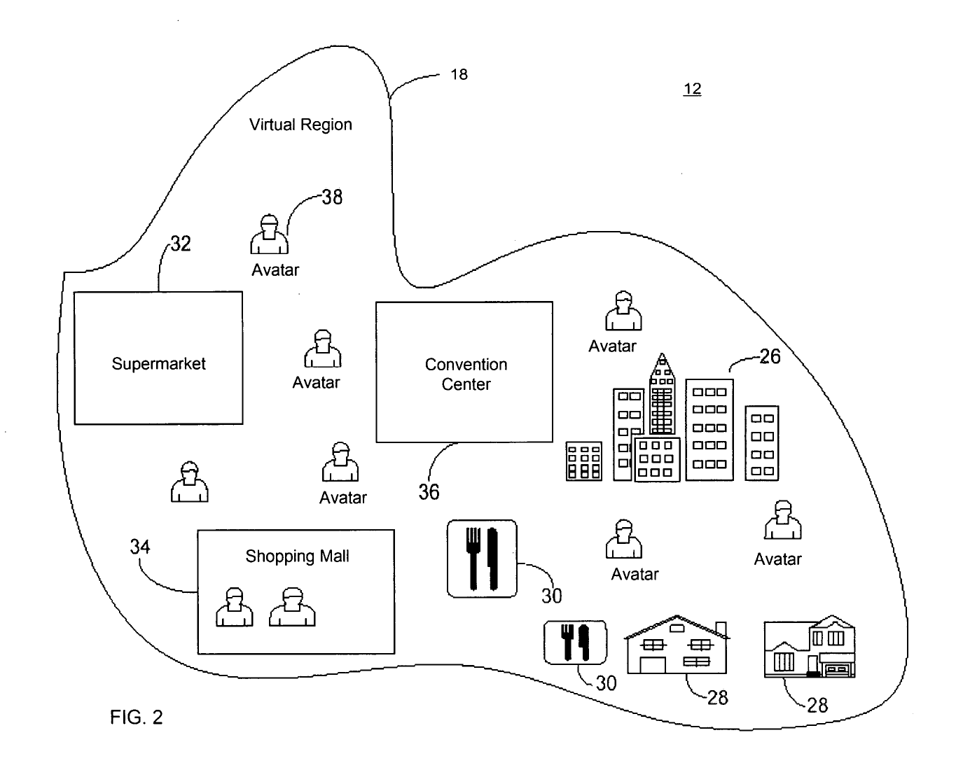

FIG. 2 shows a more detailed view of an exemplary virtual region found in virtual universe 12. As an example, virtual region 18 shown in FIG. 2 comprises virtual content, including: a downtown office center 26, homes 28, restaurants 30, a supermarket 32 and a boutique 34 for shopping, and a convention center 36 for meetings and various conventions. An avatar 38, which as mentioned above, is a persona or representation of a user of the virtual universe, roams all about the virtual region by walking, driving, flying or even by teleportation or transportation, which is essentially moving through the virtual universe from one point to another, more or less instantaneously.

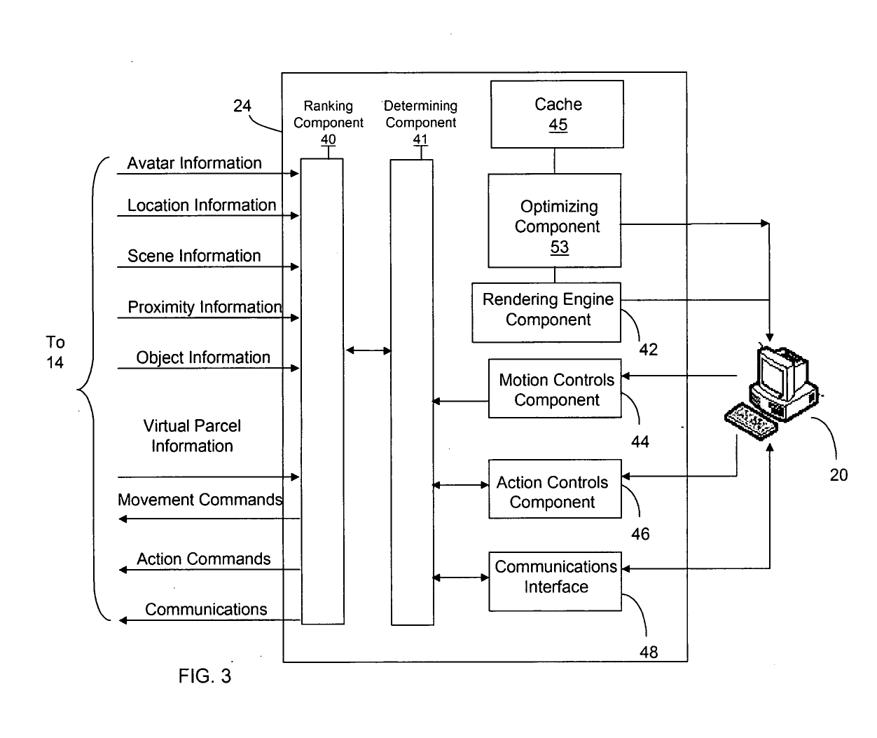

FIG. 3 shows a more detailed view of virtual universe client 24 shown in FIG. 1. Virtual universe client 24, which enables users to interact with virtual universe 12, comprises a ranking component 40, which records and ranks frequency of each communicating method invoked by a user through computer 20, as well as information received from virtual universe 12 through server array 14. A determining component 41 that performs analysis of data collected by ranking component 40 to determine the most desirable optimization technique to be applied to the most frequently used communication method. A rendering engine component 42 enables the user of computer 20 to visualize his or her avatar within the surroundings of the particular region of virtual universe 12 that the avatar is presently located.

A motion controls component 44 enables the user to make movements through the virtual universe. In one embodiment, movements through the virtual universe can include, for example, gestures, postures, walking, running, driving, flying, etc. An action controls component 46 enables the user to perform actions in the virtual universe such as buying items for his or her avatar or even for their real-life selves, building homes, planting gardens, etc. These actions are only illustrative of some possible actions that a user can perform in the virtual universe and are not limiting. A communications interface 48 enables a user to communicate with other users of virtual universe 12 through modalities such as chatting, instant messaging, gesturing, talking and electronic mail (e-mail).

An optimizing component 53 optimizes delivery of virtual universe applications to users of such application. As shown in FIG. 3, in the exemplary embodiment, optimizing component 53 resides on the same computer system as virtual universe client 24. In other embodiments, optimizing component 53 might reside on the same side as server array 14, or reside on separate computers in direct communication with virtual universe servers 16 and virtual universe client 24.

A cache 45 is provided to be used as one potential optimization technique by optimization component 53. As used herein, cache 45 is defined as a temporary storage area where frequently accessed data can be stored for rapid access. Cache 45 is a collection of data duplicating original values stored elsewhere or computed earlier, where the original data is expensive to fetch (due to slow access time), or to compute relative to the cost of reading cache 45. Once the data is stored in cache 45, future use may access the cached copy rather than downloading or re-computing the original data, resulting in a lower average access time.

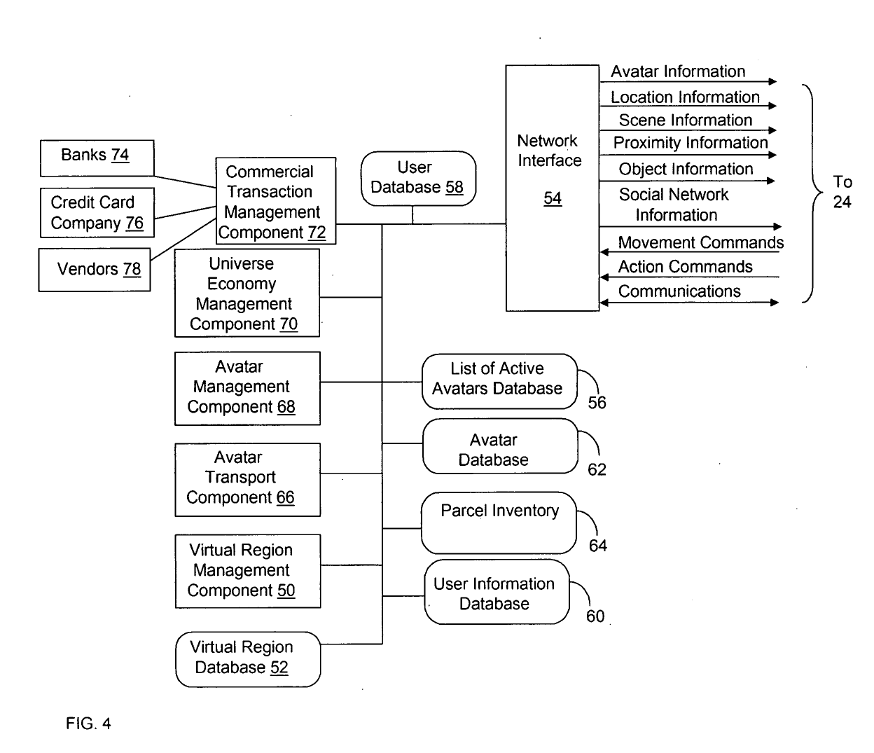

FIG. 4 shows a more detailed view of some of the functionalities provided by server array 14 shown in FIG. 1. In particular, FIG. 4 shows a virtual region management component 50 that manages a virtual region(s) within the virtual universe. Virtual region management component 50 manages what happens in a particular region, such as the type of landscape in that region, the number of homes, commercial zones, boutiques, streets, parks, restaurants, etc. For example, virtual region management component 50 would allow the owner of a particular region or establishment within the region to specify requirements for entering or remaining within the region that could potentially affect certain avatar characteristics. Those skilled in the art will recognize that virtual region management component 50 can manage many other facets within the virtual region.

FIG. 4 shows a network interface 54 that enables server array 14 to interact with virtual universe client 24 residing on computer 20. In particular, network interface 54 communicates avatar, location, parcel name and coordinates, time, scene, proximity, script and object to the user through virtual universe client 24. The network interface receives movement and action commands, as well as communications from the user via virtual universe client 24.

As shown in FIG. 4, there are several different databases for storing information. In particular, virtual region database 52 stores information on all of the specifics in virtual region 18 that virtual region management component 50 is managing. Specifically, virtual region database 52 contains metadata information about the objects, texts and scripts associated with the virtual content in the virtual region and in a particular parcel. In one embodiment, for very large virtual universes, one server 16 may be responsible for managing one particular virtual region 18 within the universe. In other embodiments, it is possible that one server 16 may be responsible for handling one particular land within virtual region 18.

Database 56 contains a list of all the avatars that are online in the virtual universe 12, while databases 58 and 60 contain information on the actual human users of virtual universe 12. In one embodiment, database 58 contains general information on the users such as names, addresses, interests, ages, etc., while database 60 contains more sensitive information on the users such as email addresses, and billing information (e.g., credit card information) for taking part in transactions. Databases 62 and 64 contain information on the avatars of the users that reside in virtual universe 12. In one embodiment, avatar database 62 contains information such as all of the avatars that a user may have, the profile of each avatar, and avatar characteristics (e.g., appearance, voice and movement features).

Those skilled in the art will recognize that databases 58-64 may contain additional information if desired. Databases 58-64 may be consolidated into a single database or table, divided into multiple database or tables, or clustered into a database system spanning multiple physical and logical devices. Further, although the above information is shown in FIG. 4 as being stored in databases, those skilled in the art will recognize that other means of storing information can be utilized. For example, parcel inventory 64 might reside on the same computers as virtual universe client 24, have components that reside on both server array 14 and virtual universe client 24, or reside on separate computers in direct communication with virtual universe servers 16 and virtual universe client 24.

An avatar transport component 66 enables users to transport, which as mentioned above, allows avatars to travel through space from one point to another point, more or less instantaneously. An avatar management component 68 keeps track of what the avatars are doing while in the virtual universe. For example, avatar management component 68 can track where each avatar presently is in the virtual universe, as well as what activities it is performing or has recently performed. It can further communicate such data to ranking component 40 (FIG. 3) to be then further analyzed by determining component 41 (FIG. 3). An illustrative but non-exhaustive list of activities can include shopping, eating, talking, recreating, etc.

Since a typical virtual universe has a vibrant economy, server array 14 (FIG. 1) has functionalities that are configured to manage the economy. In particular, a universe economy management component 70 manages transactions that occur within the virtual universe between avatars. In one embodiment, virtual universe 12 will have its own currency that users pay for with real-world money. The users can then take part in commercial transactions for their avatars through universe economy management component 70.

In one embodiment, an avatar pays for a service that provides this optimizing capability. In such an embodiment, the avatar purchases this service using the virtual universe currency.

In another embodiment, the user takes part in a commercial transaction that benefits the user and not an avatar. As such, while walking around a commercial zone, a user sees a pair of shoes that he or she would like for themselves and not their avatar. A commercial transaction management component 72 allows the user to participate in the transaction. In order to fulfill this type of transaction and others similarly related, commercial transaction management component 72 interacts with banks 74, credit card companies 76 and vendors 78.

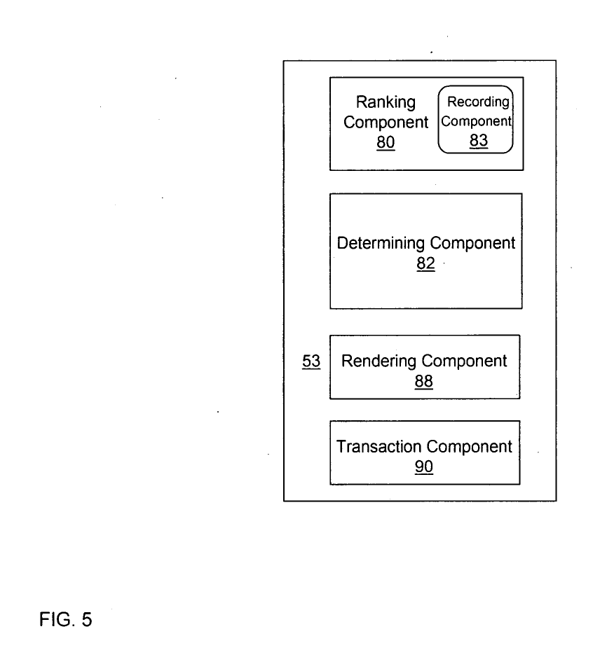

In yet another embodiment of this invention, optimizing tool 53 is used as a service to charge fees for each optimization performed. As shown in FIG. 5, optimizing tool 53 comprises a ranking component 80, which in turn comprises a recording component 83, a determining component 82, a rendering component 88 and a transaction component 90, configured to charge an optimization fee for optimizing a communication method. In this embodiment, the provider of the virtual universe or a third party service provider could offer this optimizing as a service by performing the functionalities described herein on a subscription and/or fee basis. In this case, the provider of the virtual universe or the third party service provider can create, deploy, maintain, support, etc., optimizing tool 53 that performs the processes described in the invention. In return, the virtual universe or the third party service provider can receive payment from the virtual universe residents via universe economy management component 70 and commercial transaction management component 72.

In still another embodiment, the methodologies disclosed herein can be used within a computer system to provide optimizing of the virtual content in the virtual universe. In this case, optimizing component 53 can be provided, and one or more system for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

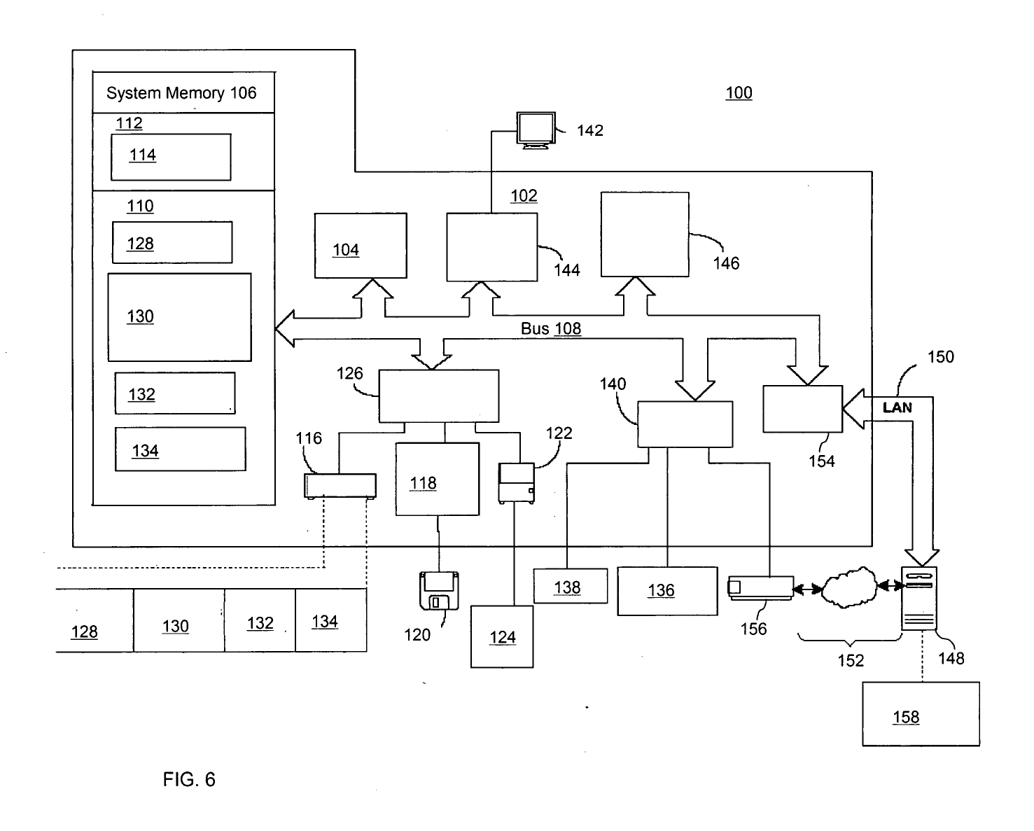

FIG. 6 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should computing environment 100 be interpreted as having any dependency or requirement relating to any one or combination of components illustrated in FIG. 6.

In the computing environment 100 there is a computer 102, which is operational with numerous other general purpose or special purpose computing system environments or configurations. Examples of well known computing systems, environments, and/or configurations that may be suitable for use with exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on that perform particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 6, computer 102 in the computing environment 100 is shown in the form of a general-purpose computing device. The components of computer 102 may include, but are not limited to, one or more processors or processing units 104, a system memory 106, and a bus 108 that couples various system components including system memory 106 to processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer 102 typically includes a variety of computer readable media. Such media may be any available media that is accessible by computer 102, and it includes both volatile and non-volatile media, removable and non-removable media.

In FIG. 6, system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 6 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on hard disk 116, magnetic disk 120, optical disk 122, ROM 112, or RAM 110, including, by way of example, and not limitation, an operating system 128, one or more application programs 130, other program modules 132, and program data 134. Each of operating system 128, one or more application programs 130 other program modules 132, and program data 134 or some combination thereof, may include an implementation of the networking environment 10 of FIG. 1 including server array 14, virtual universe client 24 and optimizing component 53. In one embodiment, the one or more application programs 130 include parts of optimizing component 53 (FIG. 3) such as ranking component 40 (FIG. 3) and determining component 41 (FIG. 3).

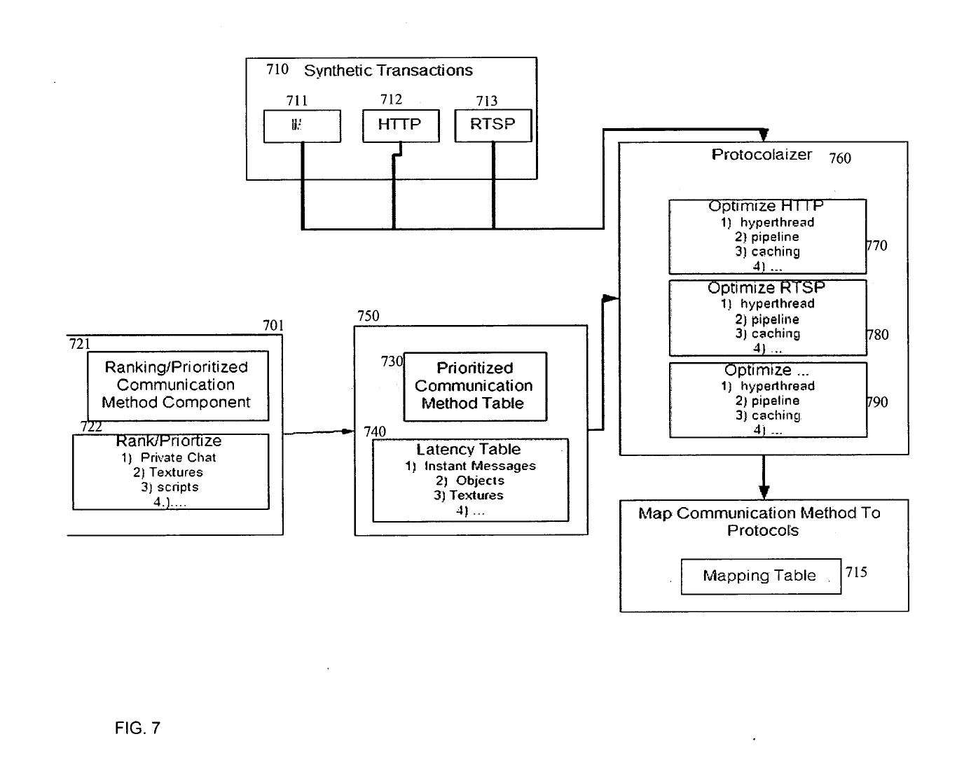

The one or more program modules 130 carry out the methodologies disclosed herein, as shown in FIG. 7. According to one embodiment, module 701 records the frequency of invocation of each communication method by the user. Such records are created at module 721 by ranking and prioritizing at module 722 of the user logs over a period of time. The most commonly used methods are then placed in a prioritized communication method table at module 730. Latency for each communication method is dynamically determined by analysis of the user experience for each communication method at module 740. The most used communication method is assigned priority delivery to the user over the other communication methods.

Protocolizer 760 evaluates communication methods against a variety of optimization techniques to determine the most efficient method to deliver that communication method to the user at that particular moment. Each method of communication is improved by using an array of specialized optimization techniques that optimize that particular communication method the most at this particular time.

In one embodiment, a test is performed to determine such best optimization technique. Module 710 illustrates all the synthetic transactions, i.e., IM 711, HTTP 712, RTSP 713, being accepted by protocolizer 760. In turn, different methods of optimization, i.e., hyperthread, pipeline, caching, etc. are performed at modules 770, 780 and 790 respectively. Results of such tests are recorded in the mapping table 715 to produce the needed correlation of communication methods to protocols. Thereafter, the best optimization technique is mapped to the prioritized list of communication methods.

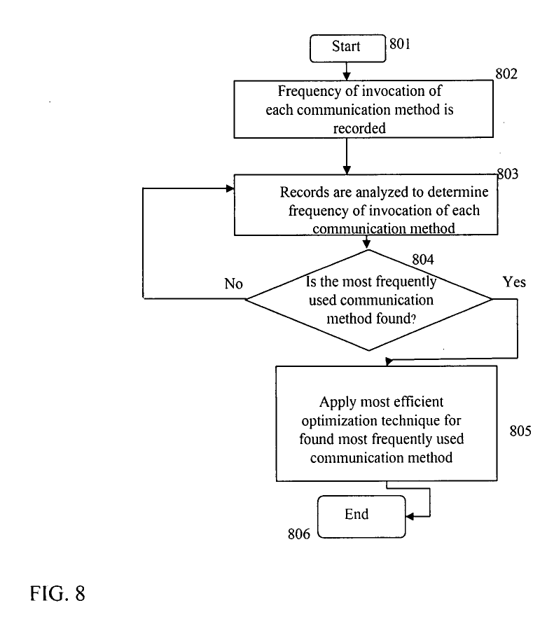

FIG. 8 illustrates a flow chart of the method for optimizing delivery of virtual universe applications to users of said virtual universe applications according to one embodiment of the invention. As illustrated, the process starts at 801. Thereby, at step 802 frequency of each communication method is recorded. Further, records are analyzed at step 803 to determine frequency of invocation of each communication method. Step 804 determines whether the most frequently used communication method is found. If it is determined that no such method is found, the process goes back to step 803 for analyzing records to determine frequency of invocation of each communication method. In case of successful determination that the most frequently used communication protocol is found, the process proceeds to step 805, where most efficient optimization technique is applied to optimize the found most frequently used communication method. The process ends at step 806.

The flow chart of FIG. 8 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Referring back to FIG. 6, a user may enter commands and information into computer 102 through optional input devices such as a keyboard 136 and a pointing device 138 (e.g., a “mouse”). Other input devices (not shown) may include a microphone, joystick, game pad, satellite dish, serial port, scanner, camera, or the like. These and other input devices are connected to processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 6 are a local area network (LAN) 150 and a general wide area network (WAN) 152. Such networking environments are commonplace in offices, enterprise-wide computer networks, intranets, and the Internet. When used in a LAN networking environment, computer 102 is connected to LAN 150 via network interface or adapter 154. When used in a WAN networking environment, the computer typically includes a modem 156 or other means for establishing communications over WAN 152. The modem, which may be internal or external, may be connected to system bus 108 via user input interface 140 or other appropriate mechanism.

In a networked environment, program modules depicted relative to computer 102, or portions thereof, may be stored in a remote memory storage device. By way of example, and not limitation, FIG. 6 illustrates remote application programs 158 as residing on a memory device of remote computer 148. It will be appreciated that the network connections shown and described are exemplary and other means of establishing a communications link between the computers may be used.

An implementation of computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

In another embodiment, there is provided a business method that performs the process of the invention on a subscription, advertising, and/or fee basis. That is, a service provider, such as a Solution Integrator, could offer to provide the functionality described herein. In this embodiment, the service provider can create, maintain, support, etc., a computer infrastructure, similar to computer 102 that performs the process of the invention for one or more customers. In return, the service provider can receive payment from the customers under a subscription and/or fee agreement and/or the service provider can receive payment from the sale of advertising content to one or more third parties.

In still another embodiment, a computer-implemented method for performing the functionality described herein is provided. In this case, a computer infrastructure, such as computer infrastructure 102, can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 102, from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

In yet another embodiment, a data processing system suitable for storing and/or executing program code is provided hereunder that includes at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, etc.

What is claimed is:

1. A method for optimizing delivery of virtual universe applications to users of said virtual universe applications, said method comprising:
ranking types of communication methods based on frequency of utilization of said communication methods by a user;
determining a most desirable optimization technique for each available communication method for said virtual universe applications, and
utilizing said most desirable optimization technique for delivering a most frequently used communication method.

2. The method according to claim 1, said ranking comprising:
recording a frequency of invoking of each communication method by a user;
analyzing recorded frequencies to identify a communication method with the highest recorded frequency; and
assigning delivery priority to said communication method with the highest recorded frequency.

3. The method according to claim 2, further comprising:
recording an average communication latency delay associated with using each said communication method.

4. The method according to claim 1, said determining comprising:
analyzing all preferred optimization techniques available for optimizing delivery of said communication method with the highest recorded frequency;
identifying an optimization technique capable of most improving said communication method, and
mapping said optimization technique to said communication method.

5. A computer system for optimizing delivery of virtual universe applications to users of said virtual universe applications, said system comprising:
at least one processing unit;
memory operably associated with the at least one processing unit; and
an optimization tool storable in memory and executable by the at least one processing unit, the optimization tool comprising:
a ranking component configured to rank types of communication methods based on frequency of utilization of said communication methods by a user;
a determining component configured to determine a most desirable optimization technique for each available communication method for said virtual universe applications, and
a utilizing component configured to utilize said most desirable optimization technique for delivering a most frequently used communication method.

6. The optimizing tool according to claim 5, said ranking component further configured to:
record a frequency of invoking of each communication method by a user;
analyze recorded frequencies to identify the communication method with the highest recorded frequency, and
assign priority delivery to said communication method with the highest recorded frequency.

7. The optimizing tool according to claim 6 further configured to:
record an average communication latency delay associated with using of each said communication method.

8. The optimizing tool according to claim 5, said determining component further configured to:
analyze all preferred optimization techniques available for optimizing delivery of said communication method with the highest recorded frequency;
identify an optimization technique capable of most improving said communication method, and
map said optimization technique to said communication method.

9. A computer-readable medium storing computer instructions, which when executed, enable a computer system to optimize delivery of virtual universe applications to users of said virtual universe applications, the computer instructions comprising:
ranking types of communication methods based on frequency of utilization of said communication methods by a user;
determining a most desirable optimization technique for each available communication method for said virtual universe applications, and
utilizing said most desirable optimization technique for delivering a most frequently used communication method.

10. The computer-readable medium according to claim 9, said ranking comprising:
recording a frequency of invoking of each communication method by a user;
analyzing recorded frequencies to identify a communication method with the highest recorded frequency, and
assigning priority delivery to said communication method with the highest recorded frequency.

11. The computer-readable medium according to claim 10, further comprising:
recording an average communication latency delay associated with using of each said communication method.

12. The computer-readable medium according to claim 9, said determining comprising:
analyzing all preferred optimization techniques available for optimizing delivery of said communication method with the highest recorded frequency;
identifying an optimization technique capable of most improving said communication method, and
mapping said optimization technique to said communication method.

13. A method for deploying an optimization tool for use in a computer system that optimizes delivery of virtual universe applications to users of said virtual universe applications, said method comprising:
providing a computer infrastructure operable to:
rank types of communication methods based on frequency of utilization of said communication methods by a user;
determine a most desirable optimization technique for each available communication method for said virtual universe applications, and
utilize said most desirable optimization technique for delivering a most frequently used communication method.

14. The computer infrastructure according to claim 13, said ranking comprising:
recording a frequency of invoking of each communication method by a user;
analyzing recorded frequencies to identify a communication method with the highest recorded frequency, and
assigning priority delivery to said communication method with the highest recorded frequency.

15. The computer infrastructure according to claim 14 further operable to record an average communication latency delay associated with using of each said communication method.

16. The computer infrastructure according to claim 13, said determining comprising:
analyzing all preferred optimization techniques available for optimizing delivery of said communication method with the highest recorded frequency;
identifying an optimization technique capable of most improving said communication method, and
mapping said optimization technique to said communication method.
